(19) United States
(12) Patent Application Publication
(10) Pub. No.: US 2022/0033241 A1
(43) Pub. Date: Feb. 3, 2022

(54) BAG-IN-KEG CONTAINERS FOR FILLING WITH A LIQUID PRODUCT

(71) Applicants: Philip Andrew WALTON, Bishop Auckland Durham (GB); Sergio SONZOGNI, Bergamo (IT)

(72) Inventors: Philip Andrew WALTON, Bishop Auckland Durham (GB); Sergio SONZOGNI, Bergamo (IT)

(21) Appl. No.: 17/278,831

(22) PCT Filed: Oct. 8, 2019
(86) PCT No.: PCT/GB2019/052847

§ 371 Date: Mar. 23, 2021

(30) Foreign Application Priority Data
Oct. 9, 2018 (GB) 1816436.8

(51) Int. Cl. B67D 1/04; B65D 77/06; B67C 3/30; B67D 1/00

(52) U.S. Cl. CPC B67D 1/0462; B65D 77/06; B67D 2001/0828; B67D 1/0004; B67C 3/30

(57) ABSTRACT

A container (1) supplied ready for filling with a liquid product such as beer includes a flexible bag (3) contained within a rigid outer body (2) with an outer space (4) in between, a first valve (6) for closing the bag (3) and a second valve (8) for closing the outer space (4). The first valve (6) is connected to a dip tube (7) which extends into the bag, and the first and second valves are contained within a neck fitting (5). The outer space (4) is pressurised to a first positive pressure relative to ambient atmospheric pressure and the bag (3) contains an oxygen-free gas such as nitrogen at a second positive pressure between the first positive pressure and atmospheric pressure.

### TECHNICAL FIELD OF THE INVENTION

This invention relates to containers of the kind which have a flexible bag contained within a rigid outer body, known as bag-in-keg containers.

### BACKGROUND

When storing and transporting certain liquid products such as beers it is important to minimise the amount of oxygen in contact with the product to prevent it from deteriorating. In conventional multiple-use beer kegs for example, the keg is purged of oxygen immediately before filling as part of the filling process. Single use kegs are generally purged with nitrogen or carbon dioxide at the time of their manufacture to drive out atmospheric oxygen so that they can be filled without the need for further purging. These kegs are generally sent out with a small residual positive pressure (0.5 to 1.0 bar) to increase the physical robustness of the keg.

An increasing volume of beer is now being transported in so-called bag-in-keg containers where the product is held in a flexible bag within an outer relatively rigid body. With such kegs, however, it is not possible to purge the inner bag to remove atmospheric oxygen as there is no through path, so the bag is evacuated by applying a negative pressure (below atmospheric pressure). This can be carried out as part of the filling process immediately before being filled with beer, but this complicates the filling process and the filling equipment. Evacuation of the bag can alternatively be carried out at the time of manufacture of the beer keg, but keg valves are designed to resist internal pressures and are generally much less effective at holding an internal vacuum. Therefore, leakage (sucking in air) may occur before the keg is filled with beer. Also, keg filling plants generally wash the keg valves after coupling to the keg but before the valves are opened. This washing is normally done using hot water or steam under pressure. If the bag is under vacuum, this increased pressure difference can have the unwanted consequence of opening the bag valve and introducing the washing medium into the bag. Another consideration is that although the bag ‘collapses’ under the applied vacuum, there are unavoidable voids within the system—inside the valve arrangement at the keg neck and within an internal dip tube which is normally used to withdraw the product, for example. If these spaces are under vacuum, when the neck valve is opened to fill a bag-in-keg, any air (i.e. oxygen) in the connection path is sucked into the bag due to this negative internal pressure. To counter this, it is normally necessary to re-vacuum the bag to ensure minimum oxygen content, again adding complication to the filling process.

### SUMMARY OF THE INVENTION

When viewed from one aspect the present invention proposes a container for filling with a liquid product, e.g. beer, including a flexible bag contained within a rigid outer body with an outer space therebetween, a first valve for closing the bag, and a second valve for closing said outer space, in which the outer space is at a first positive pressure relative to ambient atmospheric pressure, and the flexible bag contains an oxygen-free gas at a second positive pressure between that of the outer space and ambient atmospheric pressure.

Preferred oxygen-free gases include nitrogen and carbon dioxide.

The invention also provides a method of preparing a container for filling with a liquid product, e.g. beer, said container having a flexible bag contained within a rigid outer body with an outer space therebetween, a first valve for closing the bag and a second valve for closing said outer space, said method comprising the steps of:
pressurising the outer space to a first positive pressure relative to ambient atmospheric pressure;
removing air from the bag;
introducing an oxygen-free gas into the bag at a second positive pressure between said first positive pressure and ambient atmospheric pressure.

### BRIEF DESCRIPTION OF THE DRAWINGS

The following description and the accompanying drawings referred to therein are included by way of non-limiting example in order to illustrate how the invention may be put into practice. In the drawings:

FIG. 1 is a diagrammatic cross-sectional drawing of a bag-in-keg container and associated equipment;

FIG. 2 is similar view of the bag-in-keg container during evacuation of the bag;

FIG. 3 is a similar view of the bag-in-keg container showing the bag being pressurised prior to filling with liquid product.

### DETAILED DESCRIPTION OF THE DRAWINGS

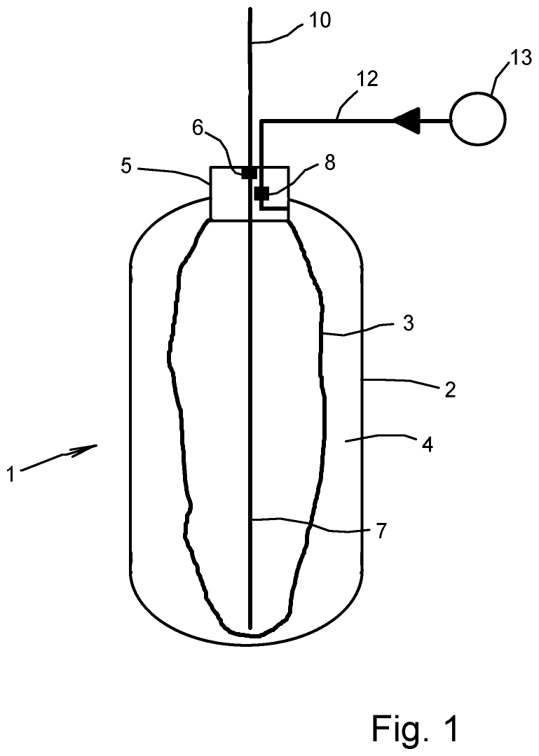

Referring firstly to FIG. 1, the bag-in-keg container 1 includes an outer relatively rigid container 2, typically blow-moulded from plastics, with a flexible inner bag 3. In the drawing the container is shown during the manufacturing process with the bag 3 in an initial partially-collapsed state, with the bag and the outer space 4 between the bag and the container all at ambient atmospheric pressure. The container 2 has a neck fitting 5 which connects the bag 3 to the container 2. The fitting 5 provides a first flow path in and out of the bag via a first valve 6 and a dip tube 7. The fitting 5 also provides a second flow path to and from the outer space 4 via a second valve 8. The valves 6 and 8 are self-closing to prevent passage of air and loss of contents, but they can be opened during filling and dispensing by means of a suitable coupling.

Preparation of the container for shipment to a filling plant takes place by connecting the first valve 6 with a feed pipe 10 which allows the bag 3 to be vented to atmosphere through the first valve 6 or connected to a source of pressurised oxygen-free gas such as carbon dioxide or nitrogen. The second valve 8 is connected to an air supply line 12 through which air may be supplied to the outer space 4 under pressure, e.g. by means of a compressor 13.

The preparation process is carried out as follows:

Stage 1

The outer space 4 is pressurised to a first positive pressure relative to ambient atmospheric pressure, say 1.0 bar, using the compressor 13 to supply compressed air via the second valve 8.

Stage 2

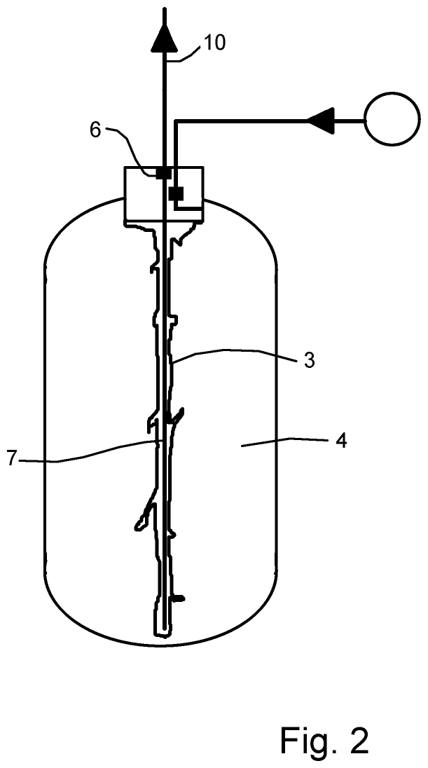

The bag 3 is evacuated to remove air. This could be achieved by opening the flow path through the valve 6 to atmosphere so that the positive pressure within the outer space 4 expels air from the bag 3 causing the bag to collapse, as shown in FIG. 2. However, it is preferred to apply a negative pressure via the valve 6, relative to atmosphere, sucking out all available oxygen-containing air from the bag. Note that there will be voids within the dip tube 7, valve 6, and the interconnecting pipework.

Stage 3

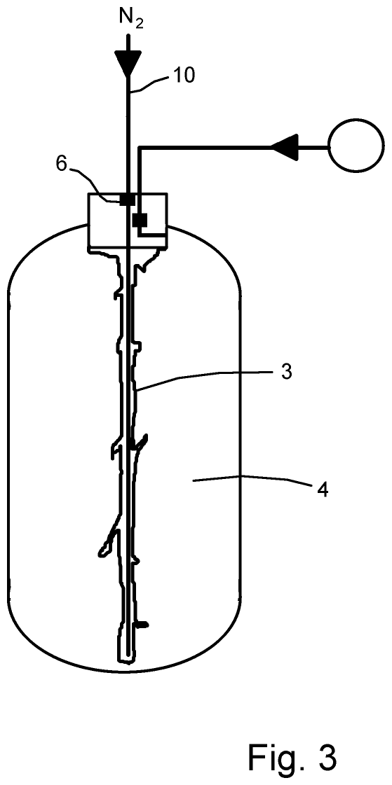

The oxygen-free gas, typically nitrogen or carbon dioxide, is introduced into the bag via the feed pipe 10, FIG. 3. The gas is supplied at a pressure between the first positive pressure within the outer space 4 and ambient atmospheric pressure, typically 0.5 bar. The bag 3 will not inflate because it is still below the surrounding pressure which is maintained within the outer space 4 (effectively a 0.5 bar negative pressure) but the oxygen-free gas will fill any evacuated voids, e.g. within the valve 6 and dip tube 7.

Stage 4

The feed pipe 10 and air line 12 are disconnected allowing the valves 6 and 8 to close.

This process has a number of advantages over previous filling methods. Firstly, since the voids become filled with oxygen-free gas (Stage 3) there is less tendency for residual oxygen-containing air to be drawn into the bag during the filling process. Secondly, since both the bag and the outer space are both at a positive pressure relative to average atmospheric pressures the valves 6 and 8 are less likely to leak and draw in air. The filling process is also quicker and the filling equipment less expensive since there is no requirement to re-vacuum the bag prior to filling.

It is important that the pressure between the bag and the keg is higher than the that of the bag itself as it serves to minimise the volume of the bag and hence the amount of gas within the bag.

Any gas present in the bag at time of filling will remain in the bag after filling along with the product, e.g. beer, so this volume needs to be minimised. If this residual gas is for example nitrogen, it will normally remain in gas form and reduce the volumetric capacity of the bag. If the gas in the bag is CO₂ it will normally dissolve into the beer during filling so carbon dioxide is preferable.

Whilst the above description places emphasis on the areas which are believed to be new and addresses specific problems which have been identified, it is intended that the features disclosed herein may be used in any combination which is capable of providing a new and useful advance in the art.

1. A container (1) for filling with a liquid product, e.g. beer, including a flexible bag (3) contained within a rigid outer body (2) with an outer space (4) therebetween, a first valve (6) for closing the bag, and a second valve (8) for closing said outer space, in which the outer space (4) is at a first positive pressure relative to ambient atmospheric pressure, and the flexible bag (3) contains an oxygen-free gas at a second positive pressure between that of the outer space and ambient atmospheric pressure.

2. A container according to claim 1 wherein the first valve (6) is connected to a dip tube (7) extending into the bag, and the dip tube contains the oxygen-free gas at the second positive pressure.

3. A container according to claim 1 wherein the first and second valves (6, 8) are incorporated in a neck fitting (5) which connects the bag (3) to the rigid outer body (2).

4. A container according to claim 1 wherein the oxygen-free gas is nitrogen.

5. A container according to claim 1 wherein the oxygen-free gas is carbon dioxide.

6. A method of preparing a container (1) for filling with a liquid product, e.g. beer, said container having a flexible bag (3) contained within a rigid outer body (2) with an outer space (4) therebetween, a first valve (6) for closing the bag and a second valve (8) for closing said outer space, said method comprising the steps of:
pressurising the outer space (4) to a first positive pressure relative to ambient atmospheric pressure;
removing air from the bag (3);
introducing an oxygen-free gas into the bag (3) at a second positive pressure between said first positive pressure and ambient atmospheric pressure.

7. A method according to claim 6 wherein the first valve (6) is connected to a dip tube (7) extending into the bag (3), and the dip tube is filled with the oxygen-free gas at the second positive pressure.

8. A method according to claim 6 wherein the first and second valves (6, 8) are incorporated in a neck fitting (5) which connects the bag (3) to the rigid outer body (2).

9. A method according to claim 6 wherein the oxygen-free gas is nitrogen.

10. A method according to claim 6 wherein the oxygen-free gas is carbon dioxide.
